(19) United States
(12) Patent Application Publication
(10) Pub. No.: US 2021/0206105 A1
(43) Pub. Date: Jul. 8, 2021

(54) SCAN CARRIAGE OF A PRINT APPARATUS

(71) Applicant: HEWLETT-PACKARD DEVELOPMENT COMPANY, L.P., Spring, TX (US)

(72) Inventors: Bruce A. AXTEN, Vancouver, WA (US); Michael B. DELEON, Jr., Vancouver, WA (US); Thomas GRIFFITHS, Vancouver, WA (US)

(73) Assignee: HEWLETT-PACKARD DEVELOPMENT COMPANY, L.P., Spring, TX (US)

(21) Appl. No.: 16/075,473

(22) PCT Filed: Apr. 21, 2017
(86) PCT No.: PCT/US2017/028831

§ 371 Date: Aug. 3, 2018

(51) Int. Cl. B29C 64/386; B29C 64/236; H04N 1/10

(52) U.S. Cl. CPC B29C 64/386; B33Y 10/00; H04N 1/103; B29C 64/236

(57) ABSTRACT

Example implementations relate to a scan carriage of a print apparatus. In some examples, a system may include a print carriage to transit across a print zone of the print apparatus and a scan carriage selectably attachable to the print carriage to transit across the print zone of the print apparatus.

### BACKGROUND

Additive manufacturing, known as three-dimensional (3D) printing, enables 3D parts to be fabricated layer-by-layer based on a 3D model of the part or parts to be fabricated. One type of 3D printing involves forming successive layers of a build material, such as a powdered build material, and successively solidifying portions of each layer of the build material to form each layer of the part or parts being fabricated.

### BRIEF DESCRIPTION OF THE DRAWINGS

FIG. 1 illustrates an example of a system including a scan carriage and a print carriage consistent with the disclosure.

FIG. 2 illustrates an example of a system including a scan carriage and a print carriage in associated with a print apparatus consistent with the disclosure.

FIG. 3 illustrates an example of a system including a scan carriage selectably attachable to a print carriage consistent with the disclosure.

FIG. 4 illustrates another example of a system including a scan carriage selectably attachable to a print carriage consistent with the disclosure.

FIG. 5 illustrates another example of a system including a scan carriage selectably attachable to a print carriage consistent with the disclosure.

FIG. 6 illustrates an example of a system including a scan carriage independently movable relative to a print carriage consistent with the disclosure.

FIG. 7 illustrates an example flow diagram illustrating an example of a method for moving a scan carriage consistent with the disclosure.

### DETAILED DESCRIPTION

Example implementations described herein relate to a scan carriage of a print apparatus. In various examples described herein, a print apparatus may be a two dimensional (2D) print apparatus and/or a three dimensional (3D) print apparatus. In some examples, a system may include a print carriage to transit across a print zone of the print apparatus and a scan carriage selectably attachable to the print carriage to transit across the print zone of the print apparatus. “Transit” is intended to mean movement into and/or travel across the print zone described herein, which may be a one-way or a two-way transit of the print carriage as many times as intended for a print operation and/or of the scan carriage for a scan operation.

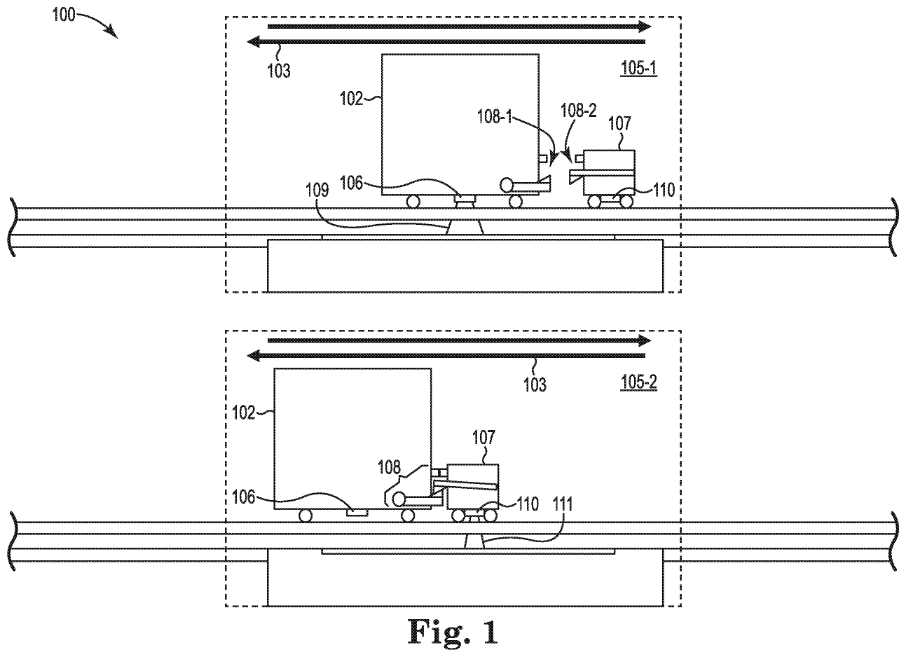

FIG. 1 illustrates an example of a system 100 including a scan carriage 107 and a print carriage 102 consistent with the disclosure. As described herein, the print carriage 102 may transit 103 across a print zone 105 while being selectably attachable via an engagement component 108 to (e.g., capable of being selectably attached to and detached from) the scan carriage 107. Various examples of the engagement component 108 are illustrated and described herein in connection with FIGS. 1-6. The scan carriage 107 may, in some examples, be detached from the print carriage 102 during a first transit 103 across the print zone, as indicated by 105-1, and attached to the print carriage 102 during a second transit 103 across the print zone, as indicated by 105-2. In some examples, as described herein, the scan carriage 107 may be attached to the print carriage 102 during the first transit across the print zone 105-1 and the second transit across the print zone 105-2.

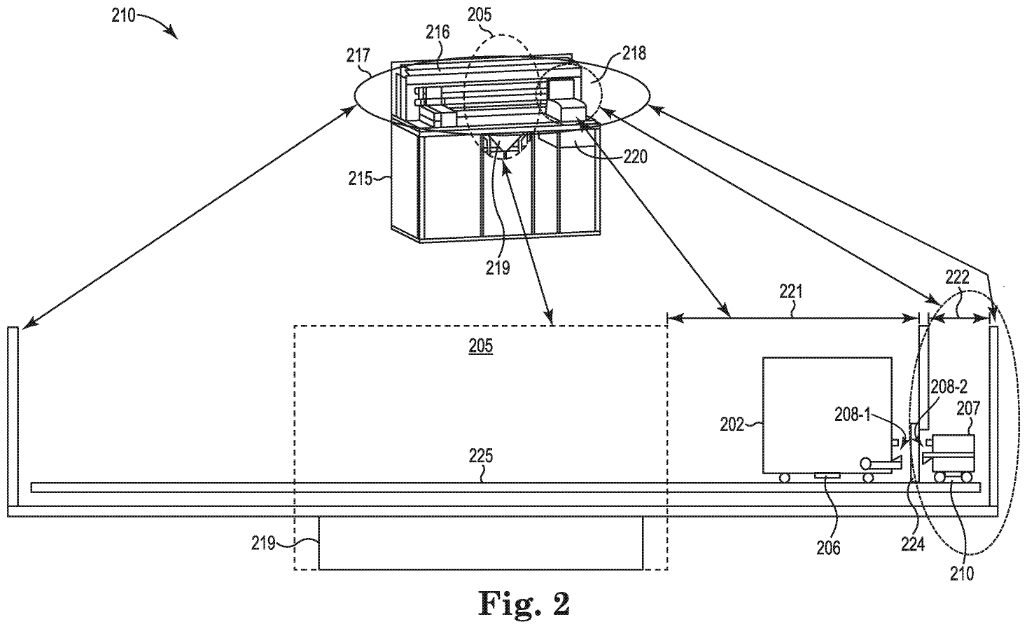

As described herein, the print zone 105 is intended to include a 3D volume in which a 3D print operation may be performed to build and/or print objects on a buildbed (e.g., as shown and described in connection with the print zone 205 of an example 3D print apparatus 215 in FIG. 2). In some examples, the print zone 105 may include a 2D layer (e.g., a print substrate, such as paper, etc.) upon which print (e.g., letters, graphics, etc.) may be formed by a 2D printer (e.g., ink-jet printers, laser printers, etc.)

The engagement component 108 shown and described in connection with FIG. 1, and at corresponding reference numbers in FIGS. 2-6, is intended to represent a completed engagement component to attach the print carriage 102 to the scan carriage 107 (e.g., to form a hitch). A first portion (e.g., as shown at 108-1 in the upper portion of FIG. 1) of the engagement component 108 associated with the print carriage 102 and a second portion (e.g., as shown at 108-2) associated with the scan carriage 107 are illustrated to represent the engagement component 108 (e.g., as shown at 108 in the lower portion of FIG. 1) prior to attachment (e.g., prior to completion of a hitch).

In contrast to the examples of 2D and/or 3D print apparatuses described herein, implementations of 2D printers (e.g., ink-jet printers, laser printers, etc.) may, in some instances, have a scanner to provide information about print quality, alignment, etc., which can be used to maintain or improve print quality. Such a scanner for the 2D printer may be mounted somewhere in a print path for a print substrate (e.g., a path upon which paper may progress during a print operation) or there may be an attachment separate from, but close to, the print path through which printed pages are sent to be scanned.

Placement of a scanner as such may be problematic in a 2D and/or a 3D print apparatus. For example, placement of a scanner by mounting the scanner anywhere near a print zone of a 3D print apparatus may expose the scanner to conditions that may be detrimental to functionality of the scanner. The conditions that may be detrimental to functionality of a scanner of a 3D print apparatus may include, for example, heat, build powder, molten material, and/or print agents, such as, fusing agents, detailing agents, colorants, etc. Some implementations of 3D print apparatuses may mitigate the effect of such conditions by, for instance, using a separate scanner mounted outside the 3D print apparatus and printing patterns on a sheet of paper that may then manually be fed through the scanner (e.g., for calibration of the 3D print apparatus). Some examples of 2D print apparatuses may utilize heat (e.g., provided by heating and/or curing lamps, etc.) that may be detrimental to functionality of the scanner.

Although specific 3D printing apparatuses and processes are described herein (e.g., a powder based 3D print apparatus and process), other 3D printing techniques such as laser sintering (e.g., selective laser sintering, metal laser sintering, etc.), stereolithography, continuous liquid interface production, etc., are contemplated within the scope of the disclosure. In some examples, a 3D print apparatus may implement a powder based 3D printing process. In such examples, after the 3D printing process is completed, a volume of fused print (build) material and a volume of unfused print (build) material may remain in the print zone 105 described herein. The unfused print material (build powder) may contribute to the conditions that may be detrimental to functionality of the scanner.

In contrast to some scanning implementations, this disclosure is directed to mounting a scanbar (e.g., a portion of which is shown at 110 in FIG. 1) on a scan carriage 107 that may, for example, be selectably attached to follow behind, or be pushed ahead of, a print carriage 102 carrying a printbar (e.g., a portion of which is shown at 106 in FIG. 1) as the scanbar 110 transits 103 across the print zone 105 to enable performance of a scan operation (e.g., performance of the scan operation indicated at 111 connected to scanbar 110). In some examples, the scan operation 111 may be performed at a static positioning of the scan carriage 107 and/or scanbar 110 in the print zone 105-2.

As described herein, a scanbar 110 is intended to mean an imaging module (e.g., a charge coupled device, a camera, etc.), scanning optics, and/or associated circuitry to enable performance of the scan operation 111. The scan carriage 107 is intended to mean a physical structure capable of supporting the scanbar 110, physical and electrical connections, and/or a drive unit, etc., to carry the scanbar 110 into or across the print zone 105 to enable performance of the scan operation 111 on a predefined object (not shown) in the print zone 105. Among various examples, the predefined object may be an outer surface of a 3D fabricated part, an uppermost layer of the 3D fabricated part visible at a time point prior to the outer surface being printed (e.g., at a time point before another layer may be printed over the previously uppermost layer); a calibration pattern printed (e.g., a grid or some other pattern printed from ink or another colorant to enable calibration of a printbar and/or the 3D print apparatus) on a sheet of print substrate (e.g., paper, among various other print substrates), a calibration pattern printed from a print material used to print the 3D fabricated part (e.g., printed on a print substrate from the print material used to form the 3D fabricated part), and/or a calibration pattern printed on the uppermost layer and/or the outer surface of the 3D fabricated part (e.g., from build powder and/or print agents, such as ink or another colorant). In some examples, the predefined object may be a grid or some other pattern formed (e.g., printed, built, and/or etched, etc.) on the buildbed (e.g., during fabrication of the buildbed). Scans of such predefined objects performed by the scanbar 110 may be used for calibration of the printbar 106 and/or the 3D print apparatus (e.g., as shown at 215 in FIG. 2), among other possible uses of such scans.

In some examples, a print operation (e.g., as indicated at 109) and the scan operation 111 may be performed in a single transit 103 across the print zone 105 (e.g., combined first transit 105-1 and second transit 105-2 across the print zone). For example, a printbar 106 associated with the print carriage 102 may be used to print a calibration pattern in the print zone 105 when a 3D fabricated part is not being built and/or the calibration pattern is not being printed from the material used to print the 3D fabricated part (e.g., when build powder is not being used). Printing as just described may enable the calibration pattern, for example, to be scanned in the print zone 105 using the scanbar 110 associated with the scan carriage 107, while the scan carriage 107 is attached to the print carriage 102, during the same transit 103 across the print zone 105. In some examples, the conditions during a 3D print operation may not be detrimental to functionality of a scanbar 110, which would enable the scan carriage 107 to be attached to the print carriage 102 during the same transit 103 across the print zone 105 and a scan operation 111 to be performed by the scanbar 110 during the same transit as the print operation 109 is performed using the printbar 106.

As described herein, the print carriage 102 is intended to mean a physical structure capable of supporting a printbar 106 (e.g., a portion of which is shown at 106 in FIG. 1), physical and electrical connections, and/or a drive unit, etc. The print carriage 102 may carry the printbar 106 into or across the print zone 105 to enable performance of a print operation to form a predefined object (not shown) (e.g., a 3D fabricated part and/or a calibration pattern printed according to a predetermined pattern) in the print zone 105. In various examples, the printbar 106 may include an aperture (e.g., a particular aperture such as a hole, nozzle, etc., or a plurality of such apertures) through which a print material is supplied to print the predefined object in the print zone 105 (e.g., during a first transit 103 across the print zone 105-1). The print material may (e.g., depending on the configuration and/or type of the 3D print apparatus) be solid and/or liquid print materials such as, for example, build powders, molten materials, print agents, etc., used to form and/or detail the predefined object in the print zone 105.

The printbar 110 may transit 103 across the print zone 105-1 to enable performance of a print operation (e.g., performance of the print operation indicated at 109 connected to printbar 106). In some examples, the print operation 109 may be performed at a static positioning of the print carriage 102 and/or printbar 106 in the print zone 105-1. The scan carriage 102 may carry the scanbar 110 that scans the predefined object in the print zone during a second transit 103 across the print zone 105-2, where the first transit 105-1 and second transit 105-2 are separate transits 103 across the print zone. In some examples, the scan carriage 107 may be attached to the print carriage 102 during the first transit across the print zone 105-1 and the second transit across the print zone 105-2, with the print operation 109 being performed during the first transit across the print zone 105-1 and the scan operation being performed during the second transit across the print zone 105-2

The scan carriage 107 may be selectably attachable (e.g., by a first actuation of the engagement component 108) to scan across the print zone 105-2 when a print operation 109 is not being performed and selectably detachable (e.g., by a second actuation of the engagement component 108). Detachment of the scan carriage 107 may allow the scan carriage 107, and the scanbar 110, to stay out of the print zone 105-1 during performance of the print operation 109, and therefore away from the associated potentially detrimental conditions. The scan carriage 107 may stay in a location (e.g., an enclosure as shown and described in connection with FIGS. 2-6) that is separated from the print zone 105-1 to further protect it during performance of the print operation 109. When intended for use in a scan operation 111 (e.g., calibration), the print carriage 102 and/or the scan carriage 107 may utilize various types of engagement components 108 (e.g., hitches, among other examples described herein) that enable attachment of the print carriage 102 to the scan carriage 107. The attachment (e.g., using a solenoid associated with a hitch on the print carriage 102 and/or the scan carriage 107, among other examples described herein) may enable removal of the scan carriage 107 from of the separated location in order to scan the predefined object in the print zone 105-2.

Hence, a number of actions may be reduced that are performed (e.g., by a user) to move the predefined object outside of the print zone 105 to be scanned by a scanner, for example, to reduce the exposure to the potentially detrimental conditions. Utilizing a scan carriage 107 that is selectably attachable and detachable from the print carriage 102 for movement into and/or travel across the print zone 105 may have other effects. For example, having the scan carriage 107, an associated scanbar 110, the print carriage 102, and an associated printbar 106, included in (e.g., connected to) the same structural components of the 3D print apparatus may enable more accurate correlation of print and scan coordinates (e.g., for calibration of the printbar 106 based on scan operations 111 performed using the scanbar 110, among other possibilities).

FIG. 2 illustrates an example of a system 210 including a scan carriage 207 and a print carriage 202 in associated with a 3D print apparatus 215 consistent with the disclosure. A printer, such as the 3D print apparatus 215 described herein, may include various components to facilitate printing of a fabricated part (e.g., a 3D fabricated part). The components of the 3D print apparatus 215 also may facilitate printing of a predefined object, as described herein, that may, for example, be associated with or part of the 3D fabricated part by being, or being on, an outer surface of the 3D fabricated part (e.g., by being, or being on, an outermost layer that is formed during fabrication of the 3D fabricated part).

In various examples, a 3D print apparatus 215 may include various components to print the 3D fabricated part and/or the predefined object (e.g., as shown within oval 217 in FIG. 2). For clarity, the oval 217 of the 3D print apparatus 215 is shown in the lower portion of FIG. 2 to extend from a left wall to a right wall of the 3D print apparatus 215. However, examples of the 3D print apparatus 215 may have the left wall, the right wall, or neither wall and still be consistent with the disclosure.

Components within the oval 217 may include those within a print zone 205 of the 3D print apparatus 215. The print zone 205 may include components such as the print carriage 202, printbar 206, scan carriage 207, and/or scanbar 210, at least during print and/or scan operations. The print zone 215 may, by way of example and not by way of limitation, include other components, such as a build area 219 (e.g., a 3D build bucket in a lower part of the print zone 205 within which the 3D fabricated part and/or the predefined object are formed), a build surface (not shown), and/or a motor (not shown) to actuate movement of a portion of the build surface (e.g., a platen) during printing of the 3D fabricated part and/or the predefined object. In some examples, the build bucket may be an integral part of the 3D print apparatus 215; however, in some examples, the build bucket may be removable or detachable from the 3D print apparatus 215.

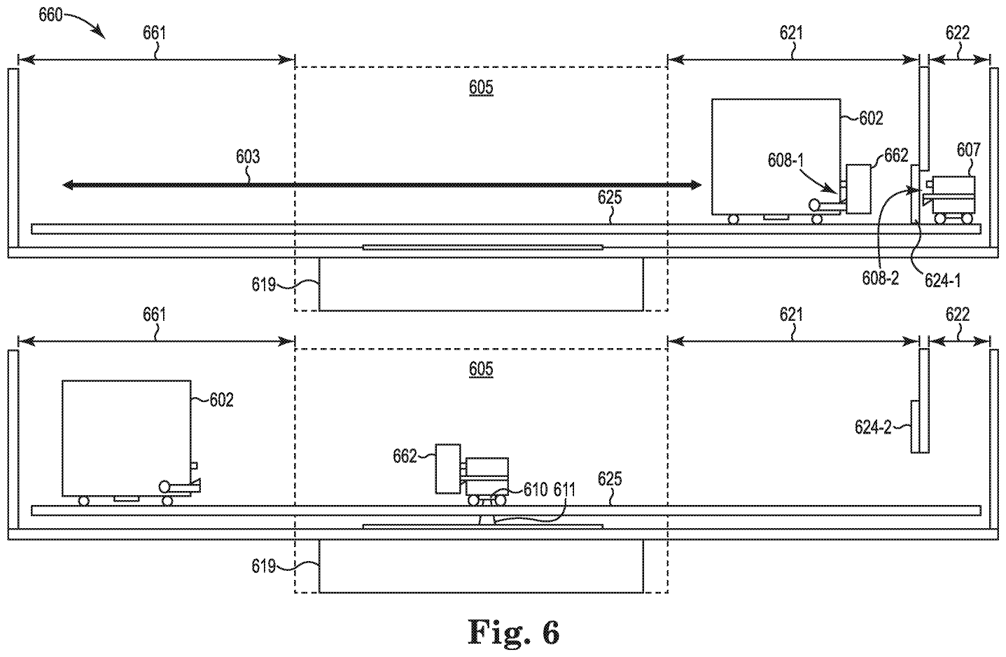

The oval 217 shown in FIG. 2 also may include a portion 218 (e.g., an area or volume) outside the print zone 205. Although the example illustrated in FIG. 2 shows the portion 218 be positioned to the right of the print zone 205, the portion may be positioned to the left or in other directions (e.g., above, below, etc.) relative to the print zone 205. The oval 217 is shown to include a back wall 216 in front of which, for example, the print zone 205, the portion 218, the print carriage 202, the printbar 206, the scan carriage 207, and/or the scanbar 210, among other components, may be positioned. Functionalities associated with the back wall 216 are shown and described in connection with FIG. 6.

Various components, areas, volumes, etc., may be associated with and/or positioned within the portion 218 of oval 217. For example, as shown in FIG. 2, the portion 218 may include a printbar service area 221 outside the print zone 205 in which the print carriage 202 and printbar 206 may reside when not performing a print operation. In some examples, maintenance, repair, and/or supply or replacement of print materials, among other service activities, for the print carriage 202 and/or printbar 206 may be performed in the printbar service area 221.

The portion 218 also may include a location 222 (e.g., a 3D enclosure) that is separated from the print zone 205 and/or the printbar service area 221 in which the scan carriage 207 and scanbar 210 may be positioned (e.g., isolated) during performance of a print operation 109 in the print zone 205. As described herein, the scan carriage 202 may be moved to the separated location 222 to reside therein in order to be isolated from conditions during the print operation 109 (e.g., heat, build powder, etc.) that may be detrimental to functionality of the scan carriage 207 and/or scanbar 210.

The separated location 222 may, in various examples, include a movable barrier 224. The movable barrier 224 may, for example, be a door that is selectably movable (e.g., opened) to enable access to the separated location 222, in which the scan carriage 207 was previously enclosed, by sliding the door, rotating the door on a hinge, and/or removing the door, among other possibilities, to provide access to the separated location 222. As such, the movable barrier 224 may enable a selectable isolation of the separated location 222 from the print zone 205 and/or the printbar service area 221 during the performance of the print operation 109, a selectable access to the scan carriage 207 for attachment to the print carriage 202 after the performance of the print operation 109, and/or a selectable access to the separated location 222 to selectably detach the scan carriage 207 for storage therein after performance of a scan operation 111. In some examples, the scan carriage 207 may reside in the separated location 222 as a default location except during performance of a scan operation 111. In some examples, the moveable barrier 224 may be closed during a scan operation 109 using the scan carriage 207 and the scanbar 210.

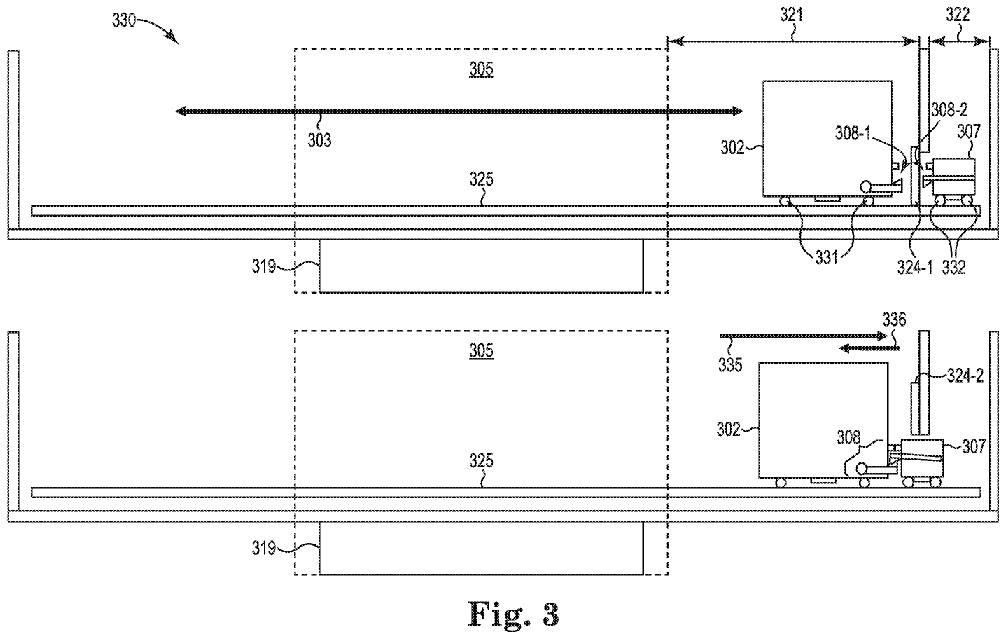

Accordingly, the scan carriage 207 may be selectably attached to the print carriage 202 after the print operation 109 for removal from the separated location 222 and for transit 103 across the print zone 205. The scan carriage 207 may be selectably attached to the print carriage 202 by selectable engagement (e.g., coupling) of a first portion 208-1 of an engagement component 208 (e.g., associated with or formed as part of the print carriage 202) to a second portion 208-2 of the component engagement 208 (e.g., associated with or formed as part of the scan carriage 207), as shown and described in more detail in connection with FIG. 3.

The transit 103 across the print zone 205 may be facilitated by the print carriage 202 and/or the attached scan carriage 207 being positioned on (e.g., mounted on or otherwise connected to) a transit component 225 (e.g., a rail, tracks, and/or a groove, among other possibilities) on which the print carriage 202 and/or the scan carriage 207 may be moved from the separated location 222 and/or the printbar service area 221 to the print zone 205 and, in some examples, beyond the print zone 205 (e.g., to the left of the print zone 205, as illustrated in FIG. 6). In some examples, the transit component 225 may be a rail, tracks, and/or a groove, among other possibilities, from which the print carriage 202 and/or the attached scan carriage 207 are suspended for transit in the print zone 205. The transit component 225 on which, or from which, the print carriage 202 and/or the scan carriage 207 may be moved may be positioned a suitable distance above the build area 219 of the print zone 205 within which the 3D fabricated part and/or the predefined object are formed so as to enable performance of both a print operation 109 and a scan operation 111.

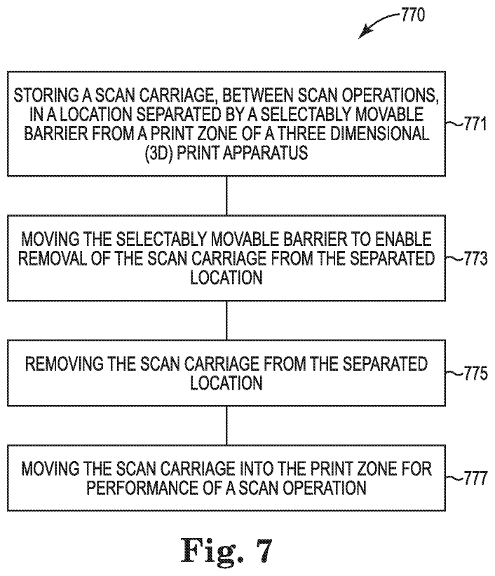

In various examples, a print apparatus (e.g., the 3D print apparatus 215 shown and described in connection with FIG. 2) may include a controller 220. The controller 220 may be associated with, or may include, a processing resource (not shown) to execute instructions to control and/or direct execution of a number of operations described herein. The instructions may be machine executable instructions stored by a non-transitory machine readable medium. The non-transitory machine readable medium may be any type of volatile or non-volatile memory or storage, such as random access memory (RAM), flash memory, read-only memory (ROM), storage volumes, a hard disk, or a combination thereof, among others. In some examples, the instructions (e.g., stored in association with controller 220) may be executable (e.g., by the processing resource) to control and/or direct execution of the print operations 109 and/or scan operations 111, among other operations described herein (e.g., operations such as the operations described in connection with FIG. 7, among others).

FIG. 3 illustrates an example of a system 330 including a scan carriage 307 selectably attachable to a print carriage 302 consistent with the disclosure. The system 330 may include the print carriage 302 being associated with and/or including a drive unit (e.g., a motor and/or a drive arm as shown at 662 and described in connection with FIG. 6) to enable transit 303 across the print zone 305 of the 3D print apparatus 215. The system 330 may include the scan carriage 307 being fabricated to transit 303 across the print zone 305 (e.g., as enabled by being selectably attached to the print carriage 302).

In some examples, a motor associated with the print carriage 302 may drive rotation of wheels 331 connected to the print carriage 302 and/or the motor associated with the print carriage 302 may drive rotation of wheels 332 connected to the scan carriage 307 to enable the transit 303 across the print zone 305 on the transit component 325. In various examples, the print carriage 302 and/or the scan carriage 307 may not include wheels to facilitate transit. In various examples, the print carriage 302 may have a wheel or a plurality of wheels powered by the drive unit and the scan carriage 307 may have runners on the bottom to be dragged along the transit component 325 to enable the transit 303 across the print zone 305. In some examples, the print carriage 302 and/or the scan carriage 307 may be enabled to transit 303 across the print zone 305 on the transit component 325 via an electromagnetic levitation component (not shown).

The system 330 may include an engagement component 308 that enables, via interaction with the print carriage 302, a transit 303 of the scan carriage 307 across the print zone 305. In some examples, the engagement component 308 can include a first portion 308-1 of a hitch and a second portion 308-2 of the hitch to selectably attach (e.g., by selectable engagement of the two portions to complete the hitch) the print carriage 302 to the scan carriage 307 for the transit 303 across the print zone 305. For example, between print operations and/or after a print operation 109, the print carriage 302 may reside in the printbar service area 321 outside the print zone 305 and/or between scan operations and/or after a scan operation 111, the scan carriage 307 may reside in the separated location 322. The movable barrier 324-1 may be closed, as shown in the upper portion of FIG. 3, to isolate the scan carriage 307 from potentially detrimental conditions associated with a print operation 109 performed in the print zone 305.

A scan operation 111 may be initiated in the print zone 305 between print operations and/or after completion of a print operation 109. For example, the scan operation 111 may be performed after a period of time has elapsed, or other operations have been performed, in order to reduce a level of the conditions (e.g., heat, aerosolized build powder, etc.) potentially detrimental to the scan carriage 307 and/or the associated scanbar.

To enable performance of the scan operation 111, the movable barrier 324-2 may be selectably opened, as shown in the lower portion of FIG. 3. When the movable barrier 324-2 is opened, the first portion 308-1 and the second portion 308-2 may be engaged (e.g., coupled) to form the engagement component 308 (e.g., hitch) to attach the print carriage 302 to the scan carriage 307. In various examples, the engagement component 308 also may include connections (e.g., as schematically shown in the upper part of the engagement component) to enable transmission of electrical signals for coordination of operations between the print carriage 302 and/or the associated printbar and the scan carriage 307 and/or the associated scanbar when attached by the engagement component 308 (e.g., hitch). For example, transmission of such electrical signals between the print carriage 302 and the scan carriage 307 may enable coordination of movement between the print carriage 302 and the scan carriage 307 and/or exchange of scan operation results for calibration of the printbar of the print carriage 302, among other possibilities.

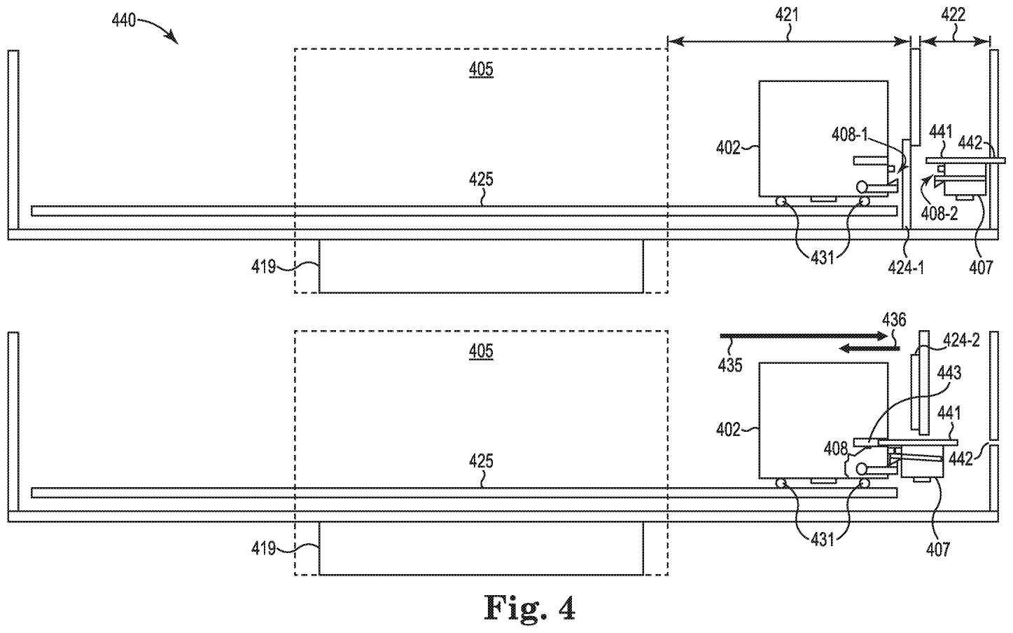

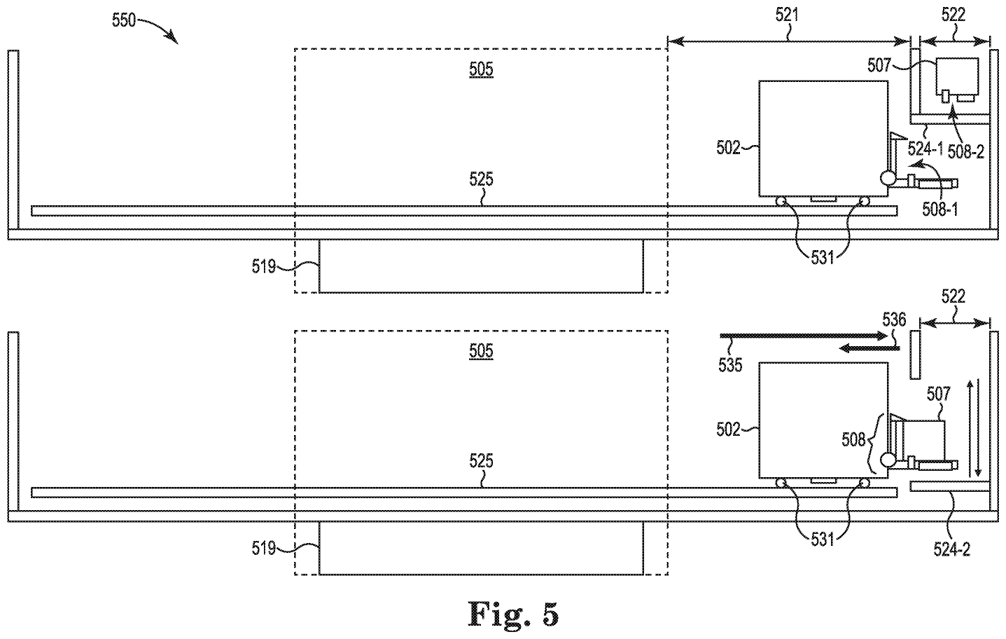

In some examples, the engagement component 308 may be associated with, or may include, a transit component 325 (e.g., a rail, tracks, a groove, among other possibilities) on which the print carriage 302 and the scan carriage 307 are mountable to aim engagement of the hitch (e.g., as schematically shown in the lower part of the engagement component 308) to attach the print carriage 302 to the scan carriage 307. In the example shown in FIG. 3, the scan carriage 307 may be mounted on a portion of the transit component 325 extending into the separated location 322 when the scan carriage resides in the separated location 322. Positioning of the scan carriage 307 at other positions in the separated location 322 are shown and described in connection with FIGS. 4 and 5.

The engagement component 308 (e.g., portion 308-1 and/or portion 308-2) may include, in various examples, a solenoid and/or spring (neither shown) that may be associated with either the print carriage 302 and/or the scan carriage 307. The solenoid and/or spring may be selectably actuatable to contribute to engagement of a hitch of the engagement component 308 between the print carriage 302 and the scan carriage 307.

For example, when the moveable barrier 324-2 is opened, the solenoid and/or spring may be used to increase a velocity and/or momentum 335 of the print carriage 302 on the transit component 325 toward the scan carriage 307 to contribute to engagement of the hitch. In some examples, the hitch may be engaged by the first portion 308-1 of the engagement component 308 entering the separated location 322 to engage the second portion 308-2 of the engagement component 308 associated with the scan carriage 307. The solenoid and/or spring may be used to increase a velocity and/or momentum 336 of the scan carriage 307 on the transit component 325 toward the print carriage 302 to contribute to engagement of the hitch. In some examples, the hitch may be engaged by the second portion 308-2 of the engagement component 308 entering the printbar service area 321 to engage the first portion 308-1 of the engagement component 308 associated with the print carriage 302. In some examples, a solenoid and/or a spring may be associated with both the print carriage 302 and the scan carriage 307 and may be used to increase a velocity and/or momentum 336 of the scan carriage 307 and the print carriage 302 on the transit component 325 toward each other to contribute to engagement of the hitch.

Hence, the print carriage 302 may carry a printbar (e.g., as shown at 206 in FIG. 2) that prints a predefined object, as described herein, in the print zone 305 during a first transit 303 (e.g., which may be a plurality of transits) across the print zone 305. After the predefined object is printed, a closed moveable barrier 324-1 may be selectably actuated to become an opened moveable barrier 324-2 that enables formation of a hitch by the engagement component 308 to attach the print carriage 302 to the scan carriage 307. In some examples, opening the moveable barrier 324-2 may enable the engagement component 308 to be formed by allowing a permanent magnet and/or an electromagnet associated with the print carriage 302 and/or the scan carriage to attach the print carriage 302 and the scan carriage.

The scan carriage 307 may carry a scanbar (e.g., as shown at 210 in FIG. 2) that scans the predefined object in the print zone 305 during a second transit 303 across the print zone 305. As described herein, the first and second transits are intended to mean separate transits across the print zone in which the scan carriage 307 is not attached to the print carriage 302 during performance of a print operation 109 using the print carriage 302. The scan operation 111 may be performed at a static position in the print zone 305 or by a particular transit or a plurality of transits across the print zone 305. The second transit across the print zone 305 may, in some examples, be used for calibration of the printbar 206 carried by the print carriage 302.

FIG. 4 illustrates another example of a system 440 including a scan carriage 407 selectably attachable to a print carriage 402 consistent with the disclosure. As described herein, the scan carriage 407 may, in various examples, not include wheels, or other mechanical components, to facilitate transit across the print area 405 on the transit component 425.

For example, an engagement component 408 that enables, via interaction with the print carriage 402, transit of the scan carriage 407 across the print zone 405 may enable the scan carriage 407 to be mounted on a first support structure 442 in the separated location 422. In the example shown in FIG. 4, the transit component 425 is shown to not extend into the separated location 422. However, in various examples, the transit component 425 may extend partially into the separated location 422, or as far into the separated location 422 as shown in FIG. 3, to facilitate engagement of the first portion 408-1 of the engagement component 408 associated with the print carriage 402 with the second portion 408-2 of the engagement component 408 associated with the scan carriage 407 (e.g., as shown in the upper portion of FIG. 4) to form the complete engagement component 408 (e.g., as shown in the lower portion of FIG. 4).

The scan carriage 407 may be associated with, or may include, a support component 441 that facilitates support of the scan carriage 407 in the separated location 422. In some examples, the scan carriage 407 may be supported by the support component 441 engaging the first support structure 442 when the moveable barrier 424-1 is closed. The scan carriage 407 may be supported in the separated location 422 even though there may be no portion of the transit component 425 underneath the scan carriage 407. In the example shown in FIG. 4, a right side of the support component 441 engages the first support structure 442 in the separated location 422 by being inserted into a slot in a far right wall of the separated location 422. However, examples of the support component 441 and the first support structure 442 in the separated location 422 are not limited to this example.

When the moveable barrier 424-2 is opened, the print carriage 402 may engage the support component 441 by interaction with a second support structure 443, for example, associated with, or part of, the first portion 408-1 of the engagement component 408 associated with the print carriage 402. In some examples, wheels 431 connected to the print carriage 402 may enable the print carriage 402 to partially enter 435 the separated location 422 on the transit component 425 to engage the left side of the support component 441 with the second support structure 443 and/or engage the first portion 408-1 of the engagement component 408 associated with the print carriage 402 with the second portion 408-2 of the engagement component 408 associated with the scan carriage 407 to form the complete engagement component 408.

The print carriage 402 may then reverse direction 436 on the transit component 425 to disengage the right side of the support component 441 from the first support structure 442 and remove the scan carriage 407, supported by the print carriage 402, from the separated location 422 for transit across the print zone 405. In some examples, the solenoid and/or spring, described in connection with FIG. 3, may be used to increase a velocity and/or momentum of the print carriage 402 on the transit component 425 toward the scan carriage 407 to contribute to engagement of the left side of the support component 441 with the second support structure 443 and/or engagement component 408 (e.g., to form a hitch, among other attachment implementations).

FIG. 5 illustrates another example of a system 550 including a scan carriage 507 selectably attachable to a print carriage 502 consistent with the disclosure. As described in connection with FIG. 4, the scan carriage 507 may, in various examples, not include wheels, or other mechanical components, to facilitate transit across the print area 505 on the transit component 525.

For example, a second portion 508-2 of an engagement component 508 that enables, via interaction with the print carriage 502, transit of the scan carriage 507 across the print zone 505 may enable the scan carriage 507 to be mounted on a support structure (not shown) in the separated location 522 (e.g., as shown in the upper portion of FIG. 5). In some examples, the scan carriage 507 may be mounted on the support structure in the separated location 522 via a component (not shown) that is different from the second portion 508-2 of an engagement component 508.

The separated location 522 illustrated in FIG. 5 may be positioned at a location not aligned with the print carriage 502 on the transit component 525. For example, the separated location 522 may be positioned at a location that is above (as shown in FIG. 5), below, to the right or to the left of the transit component 525, among other possible angles in between these directions. The separated location 522 being positioned at a location not aligned with the transit component 525 (e.g., in combination with a moveable barrier 524-1 that is closed) may further contribute to isolation of the scan carriage 507 and/or associated scanbar from the potentially detrimental conditions associated with a print operation 109 performed in the print zone 505.

In the example shown in FIG. 5, when the moveable barrier 524-2 is opened (e.g., as shown in the lower portion of FIG. 5), the scan carriage 507 may be lowered from a position above a first portion 508-1 of the engagement component 508 to form a complete engagement component 508. In some examples, the moveable barrier 524-2 may be selectably lowered to an open position by actuation of a motor (not shown) and/or the moveable barrier 524-1 may be raised to closed position by actuation of the motor.

The transit component 525 is shown to not extend into a space below the separated location 522. However, in various examples, the transit component 525 may extend partially into the space below the separated location 522, or as far into the space below the separated location 522 to facilitate engagement of the first portion 508-1 of the engagement component 508 associated with the print carriage 502 with the second portion 508-2 of the engagement component 508 associated with the scan carriage 507 separate location in order to form the complete engagement component 508 (e.g., as shown in the lower portion of FIG. 5).

In some examples, the scan carriage 507 may be supported by the support structure engaging a component (e.g., the first portion 508-1 of the engagement component 508) when the moveable barrier 524-1 is closed. The scan carriage 507 may be supported in the separated location 522, for example, by the support structure being associated with, or part of, the moveable barrier 524-1. As such, lowering and/or raising the scan carriage 507 may be facilitated by lowering and/or raising the moveable barrier (e.g., by selectable actuation of the motor).

When the moveable barrier 524-2 is opened, the print carriage 502 may engage the second portion 508-2 of the engagement component 508 associated with the scan carriage 507 by interaction with the first portion 508-1 of the engagement component 508 associated with the print carriage 502. In some examples, wheels 531 connected to the print carriage 502 may enable the print carriage 502 to partially enter 535 the space below the separated location 522 on the transit component 525 to engage the first portion 508-1 of the engagement component 508 associated with the print carriage 502 with the second portion 508-2 of the engagement component 508 associated with the scan carriage 507 to form the complete engagement component 508. The print carriage 502 may then reverse direction 536 on the transit component 525 to remove the scan carriage 507, supported by the print carriage 502, from the space below the separated location 522 for transit across the print zone 505. In some examples, the solenoid and/or spring, described in connection with FIG. 3, may be used to increase a velocity and/or momentum of the print carriage 502 on the transit component 525 toward the scan carriage 507 to contribute to engagement of the engagement component 508 (e.g., to form a hitch, among other attachment implementations).

FIG. 6 illustrates an example of a system 660 including a scan carriage 607 independently movable relative to a print carriage 602 consistent with the disclosure. The configuration of the system 660 illustrated in FIG. 6 is similar to that of the system 330 shown and described in connection with in FIG. 3 except that an exchange component (not shown), which may be associated with, or part of, an engagement component 608, may be utilized to facilitate exchange of a drive unit 662 to enable transit 603 of the scan carriage 607 and/or the print carriage 602 independently across the print zone 605.

For example, the drive unit 662 may include, or may be, a motor. The motor may be connected (e.g., via engagement of a first portion 608-1 of an engagement component 608) to the print carriage 602 to drive (e.g., by rotation of wheels along a transit component 625) the print carriage 602 during transit 603 across the print zone 605 for performance of a print operation 109. After performance of the print operation 109, the drive unit 662 may drive the print carriage 602 toward the separated location 622 in which the scan carriage 607 resides behind a moveable barrier 624-1 that is closed. In various examples, the separated location 622 may be formed and/or positioned as shown and described in connection with FIGS. 4 and/or 5.

The first portion 608-1 and/or the second portion 608-2 of the engagement component 608 may be associated with, or may be part of, the exchange component for exchange of the drive unit 662 from the print carriage 602 to the scan carriage 607 to enable the scan carriage 607 to independently transit 603 across the print zone 605. For example, when the movable barrier 624-2 is opened, the drive unit 662 may be exchanged from the first portion 608-1 to the second portion 608-2 associated with the scan carriage 607 to independently drive (e.g., by rotation of wheels along the transit component 625) the scan carriage 607 during transit 603 across the print zone 605 for performance of a scan operation 611 using a scanbar 610.

Prior to performance of the scan operation 611, the print carriage may be moved along the transit component 625 (e.g., via the exchange component or otherwise) to a storage area 661 outside the print zone 605 and on an opposite side of the print zone 605 from a printbar service area 621. Storage of the print carriage 602 in the storage area 661 on the opposite side of the print zone 605 from the printbar service area 621 may enable the drive unit 662 to return the scan carriage 607 to the separated location 622 after performance of the scan operation 611. The drive unit 662 associated with the second portion 608-2 of the engagement component 608 is then accessible for exchange, via the exchange component, to the first portion 608-1 of the engagement component 608 associated with the print carriage 602 (e.g., for subsequent performance of a print operation 109).

In another example, the drive unit 662 may represent a drive arm that may be a portion of the exchange component visible in front of the back wall 216 shown and described in connection with FIG. 2. A motor may be positioned behind the back wall 216 and the motor may be connected (e.g., by a belt, gears, etc.) to the drive arm in front of the back wall 216, in which, for example, the print zone 605, the print carriage 602, the scan carriage 607, among other components, also may be positioned.

The exchange component may be selectably actuated to exchange the drive unit 662 (e.g., the drive arm). The drive arm may be exchanged by transfer of engagement of the drive arm with a first portion 608-1 of the engagement component 608 associated with the print carriage 602 to engagement with the second portion 608-2 of the engagement component 608 associated with the scan carriage 607, and vice versa. Hence, exchange of engagement of the drive arm, via the exchange component, may enable the print carriage 602 and the scan carriage 607 to independently transit 603 across the print zone 605.

The various examples shown in connection with FIGS. 3-6 describe implementations in which the scan carriage may be mechanically, electically, and/or magnetically removed from the separated location for attachment to the print carriage and/or for transit across a print zone. However, in some examples, the scan carriage may be manually removed (e.g., by a user) from the separated location for attachment to the print carriage and/or for attachment a drive unit to enable transit across the print zone.

FIG. 7 illustrates an example flow diagram illustrating an example of a method 770 for moving a scan carriage consistent with the disclosure. At 771, the method 770 may include storing a scan carriage, between scan operations, in a location separated by a selectably movable barrier from a print zone of a 3D print apparatus. At 773, the method 770 may include moving (e.g., opening) the selectably movable barrier to enable removal of the scan carriage from the separated location. At 775, the method 770 may include removing the scan carriage from the separated location (e.g., through the opened movable barrier). At 777, the method 770 may include moving the scan carriage into the print zone for performance of a scan operation (e.g., for calibration of the 3D print apparatus).

In some examples, the method 770 may include utilizing a drive unit (e.g., a motor as described in connection with FIGS. 2-6 and/or a drive arm as described in connection with FIG. 6) associated with the print carriage to remove the scan carriage from the separated location and to move the scan carriage into the print zone. In some examples, the motor associated with the print carriage may be a part of the print carriage such that the print carriage is attached to the scan carriage to enable the scan carriage to be removed from the separated location and to transit across the print zone. In some examples, the motor associated with the print carriage may be exchanged between the print carriage and the scan carriage to enable independent transit of each across the print zone (e.g., as described in connection with FIG. 6). Alternatively or in addition, such independent transit of each across the print zone also may be enabled by exchange of the drive arm (e.g., as described in connection with FIG. 6).

In some examples, the method 770 may include moving the scan carriage from a position in the separated location for attachment to a print carriage. Moving the scan carriage from the position may, among various examples, include detaching a support component (e.g., as shown at 441 and described in connection with FIG. 4) of the scan carriage from a first support structure (e.g., as shown at 442) at a first position (e.g., as shown in the separated location 422 in FIG. 4) to attach the support component to a second support structure (e.g., as shown at 443) of the scan carriage. Alternatively or in addition, moving the scan carriage from the position may include moving the scan carriage substantially vertically in the separated location (e.g., as shown in the separated location 522 in FIG. 5) from a second position (e.g., as shown near the closed moveable barrier 524-1) to engage a third support structure (e.g., as shown at 508-1) of the scan carriage.

In the foregoing detailed description of the disclosure, reference is made to the accompanying drawings that form a part hereof, and in which is shown by way of illustration how examples of the disclosure may be practiced. These examples are described in sufficient detail to enable those of ordinary skill in the art to practice the examples of this disclosure, and it is to be understood that other examples may be utilized and that process, electrical, and/or structural changes may be made without departing from the scope of the disclosure.

The figures herein follow a numbering convention in which the first digit corresponds to the drawing figure number and the remaining digits identify an element or component in the drawing. For example, reference numeral 102 may refer to element “02” in FIG. 1 and an analogous element may be identified by reference numeral 202 in FIG. 2. Multiple analogous elements within one figure may be referenced with a reference numeral followed by a hyphen and another number or a letter. For example, 208-1 may reference element 08-1 in FIGS. 2 and 208-2 may reference element 08-2, which can be analogous to element 08-1. Such analogous elements may be generally referenced without the hyphen and an extra numeral or letter. For example, elements 208-1 and 208-2 may be generally referenced as 208 (e.g., when attached to each other). Elements shown in the various figures herein can be added, exchanged, and/or eliminated so as to provide a number of additional examples of the disclosure. In addition, the proportion and the relative scale of the elements provided in the figures are intended to illustrate the examples of the disclosure, and should not be taken in a limiting sense.

What is claimed:

1. A system, comprising:
a print carriage to transit across a print zone of a print apparatus; and
a scan carriage selectably attachable to the print carriage to transit across the print zone of the print apparatus.

2. The system of claim 1, wherein:
the print carriage carries a printbar that comprises an aperture through which a print material is supplied to print a predefined object in the print zone during a first transit across the print zone;
the scan carriage carries a scanbar that scans the predefined object in the print zone during a second transit across the print zone; and
the first and second transits are separate transits across the print zone.

3. The system of claim 2, wherein the predefined object is selected from:
an outer surface of a 3D fabricated part;
an uppermost layer of the 3D fabricated part visible at a time point prior to the outer surface being printed;
a calibration pattern printed on a sheet of print substrate;
the calibration pattern printed from a print material used to print the 3D fabricated part; and
the calibration pattern printed on the outer surface or the uppermost layer of the 3D fabricated part.

4. The system of claim 1, wherein:
the print carriage carries a printbar that prints a predefined object in the print zone during a first transit across the print zone;
the scan carriage carries a scanbar that scans the predefined object in the print zone, during a second transit across the print zone, for calibration of the printbar carried by the print carriage; and
the first and second transits are separate transits across the print zone.

5. The system of claim 1, wherein:
the scan carriage is positioned in a location that is separated from the print zone during performance of a print operation in the print zone; and
the scan carriage is selectably attached to the print carriage after the print operation for removal from the separated location and for a transit across the print zone.

6. The system of claim 5, wherein the separated location comprises:
a movable barrier to enable:
a selectable isolation of the separated location from the print zone during the performance of the print operation;
a selectable access to the scan carriage for attachment to the print carriage after the performance of the print operation; and
a selectable access to the separated location to selectably detach the scan carriage for storage therein after performance of a scan operation.

7. A system, comprising:
a print carriage associated with a drive unit to enable transit across a print zone of a three dimensional (3D) print apparatus;
a scan carriage to transit across the print zone of the 3D print apparatus; and
an engagement component that enables, via interaction with the print carriage, a transit of the scan carriage across the print zone.

8. The system of claim 7, wherein the engagement component comprises a hitch to selectably attach the print carriage to the scan carriage for the transit across the print zone.

9. The system of claim 8, wherein the engagement component further comprises connections to enable transmission of electrical signals between the print carriage and the scan carriage when attached by the hitch.

10. The system of claim 7, wherein the engagement component comprises a solenoid associated with either the print carriage or the scan carriage, the solenoid selectably actuatable to contribute to engagement of a hitch between the print carriage and the scan carriage.

11. The system of claim 7, wherein the engagement component comprises an exchange component for exchange of the drive unit from the print carriage to the scan carriage to enable the scan carriage to independently transit across the print zone.

12. The system of claim 7, wherein the engagement component comprises a transit component on which the print carriage and the scan carriage are mountable to aim engagement of a hitch to attach the print carriage to the scan carriage.

13. A method, comprising:
storing a scan carriage, between scan operations, in a location separated by a selectably movable barrier from a print zone of a three dimensional (3D) print apparatus;
moving the selectably movable barrier to enable removal of the scan carriage from the separated location;
removing the scan carriage from the separated location; and
moving the scan carriage into the print zone for performance of a scan operation.

14. The method of claim 13, further comprising:
utilizing a drive unit associated with the scan carriage to remove the scan carriage from the separated location and to move the scan carriage into the print zone.

15. The method of claim 13, further comprising:
moving the scan carriage from a position in the separated location for attachment to a print carriage; and
wherein moving the scan carriage from the position is selected from:
detaching a support component of the scan carriage from a first support structure at a first position to attach the support component to a second support structure of the scan carriage; and
moving the scan carriage substantially vertically in the separated location from a second position to engage a third support structure of the scan carriage.
